(19) United States
(12) Patent Application Publication
(10) Pub. No.: US 2001/0046660 A1
(43) Pub. Date: Nov. 29, 2001

(54) Systems and methods for just-in-time construction training and real time productivity statistical analysis

(76) Inventor: Chris A. Krueger, Castle Rock, CO (US)

Correspondence Address: Curtis A. Vock, LATHROP & GAGE, Suite 302, 4845 Pearl East Circle, Boulder, CO, 80301, US

(21) Appl. No.: 09/765,866

(22) Filed: Jan. 19, 2001

Related U.S. Application Data
(60) Provisional application No. 60/176,858, filed on Jan. 19, 2000.
(60) Provisional application No. 60/192,240, filed on Mar. 27, 2000.

(51) Int. Cl. G09B 19/00

(52) U.S. Cl. 434/219

(57) ABSTRACT

The invention relates to systems and methods for providing just-in-time construction assistance to contractors in need of assistance. One object of the invention is to provide systems and methods which assist contractors with just-in-time construction services. Another object is to provide real time productivity analysis tools for statistical process control techniques to assist in improving construction jobs.

### RELATED APPLICATION

This application is a non-provisional application which claims the priority of prior provisional application Ser. No. 60/176,858, entitled “SYSTEMS AND METHODS FOR JUST-IN-TIME CONSTRUCTION TRAINING AND REAL TIME PRODUCTIVITY STATISTICAL ANALYSIS”, filed Jan. 19, 2000 and provisional application Ser. No. 60/192,240, entitled SYSTEMS AND METHODS FOR JUST-IN-TIME CONSTRUCTION TRAINING AND REAL TIME PRODUCTIVITY STATISTICAL ANALYSIS, filed Mar. 27, 2000, which is hereby incorporated by reference into this application.

### FIELD OF THE INVENTION

The invention relates to systems and methods for providing just-in-time construction assistance to contractors in need of assistance.

### BACKGROUND OF THE INVENTION

The construction industry is facing a severe shortage of construction workers in all trades. This is a problem of national size, which will continue for at least a generation. Construction work is seldom an industry of choice for young people entering the work force. There is a need to improve and enhance construction services to improve the industry, particularly in training and statistical process control.

One object of the invention is thus to provide systems and methods which assist contractors with just-in-time construction services. Another object is to provide real time productivity analysis tools for statistical process control techniques to assist in improving construction jobs. These and other objects will be apparent in the description that follows.

### SUMMARY OF THE INVENTION

In one aspect, the invention provides a computerized display interface (e.g., a personal computer can provide one such display interface) which is mobile for transportation to construction sites. In one embodiment, the display interface has a video port for playing a video of narrated construction footage, as discussed herein. In another embodiment, narrated construction footage is communicated to the display interface through the Internet, wireless techniques, satellite communication, mixtures thereof, and/or the like.

In another aspect, construction footage is shot, edited and narrated in a format that allows the on-site construction worker to immediately perform the work shown on the footage. Given the wide range of scenarios that can face the worker, in the field, one aspect of the invention provides relevant construction footage to the on-site contractor in near real-time.

In still another aspect, initial training through footage is preferably followed with statistical process control techniques, including field presentations, to assist new workers on focusing and improving productivity. In a preferred aspect, these same statistical techniques can be used to analyze and improve current and planned construction operations.

In accord with a further aspect, a web site is provided and tied to the transmittal or maintenance of construction footage. Through the web site, established customers can conduct virtual consulting over the web, and preferably based on the process control techniques. The virtual consulting includes information gathered by construction field personnel that is reviewed and analyzed by personnel operating the web site.

The invention has several advantages. With the shortfall of competent construction assistance, the invention augments newer and inexperienced contractors with knowledge to equip them for virtually any job, and in near real time. The combination of (a) initial just in time training with (b) statistical process control techniques and (c) graphic display of relevant findings in understandable format provides a formidable way tool for users of the invention to succeed and improve in construction jobs. Each part (a)-(c) can, however, be executed separately, as those skilled in the art can appreciate.

The invention further adds value to the construction industry by enhancing construction productivity, particularly in the area of construction worker craft training and productivity analysis and improvement. The company will be divided into two main groups. The first group will provide construction worker craft training, using video and web based access, providing the construction contractor with the ability to train and immediately use the newly-hired construction worker.

The invention is next described further in connection with preferred embodiments, and it will become apparent that various additions, subtractions, and modifications can be made by those skilled in the art without departing from the scope of the invention.

### BRIEF DESCRIPTION OF INVENTION

A more complete understanding of the invention may be obtained by reference to the drawings, in which:

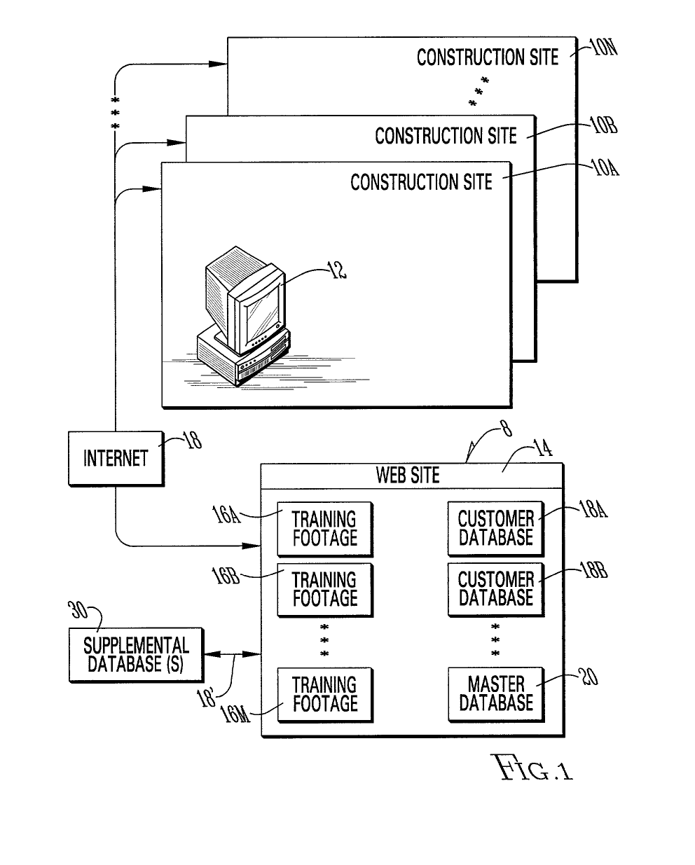

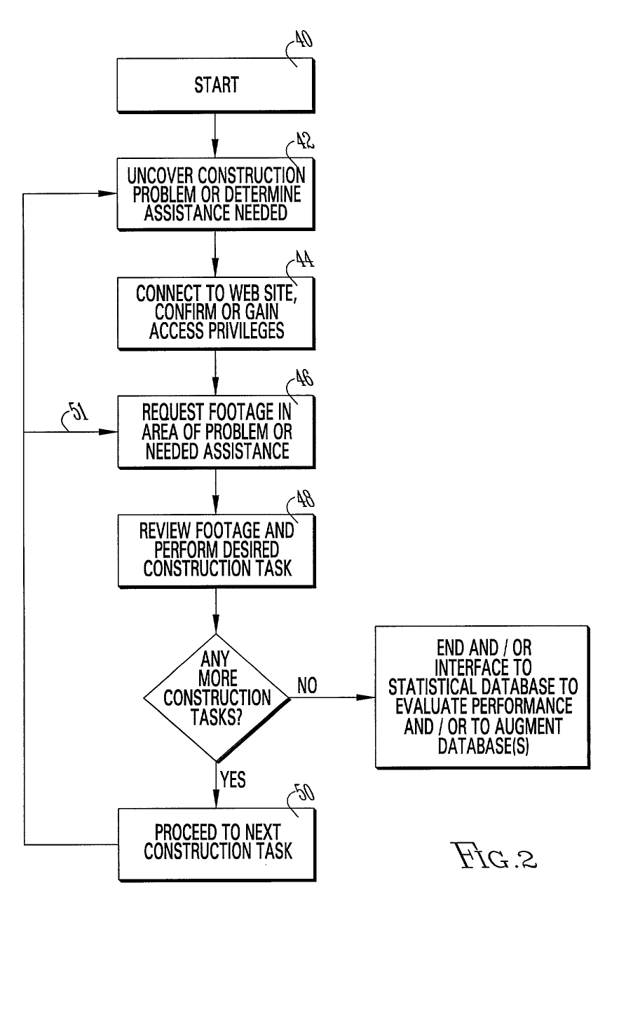

FIG. 1 shows a web site system constructed according to the invention;

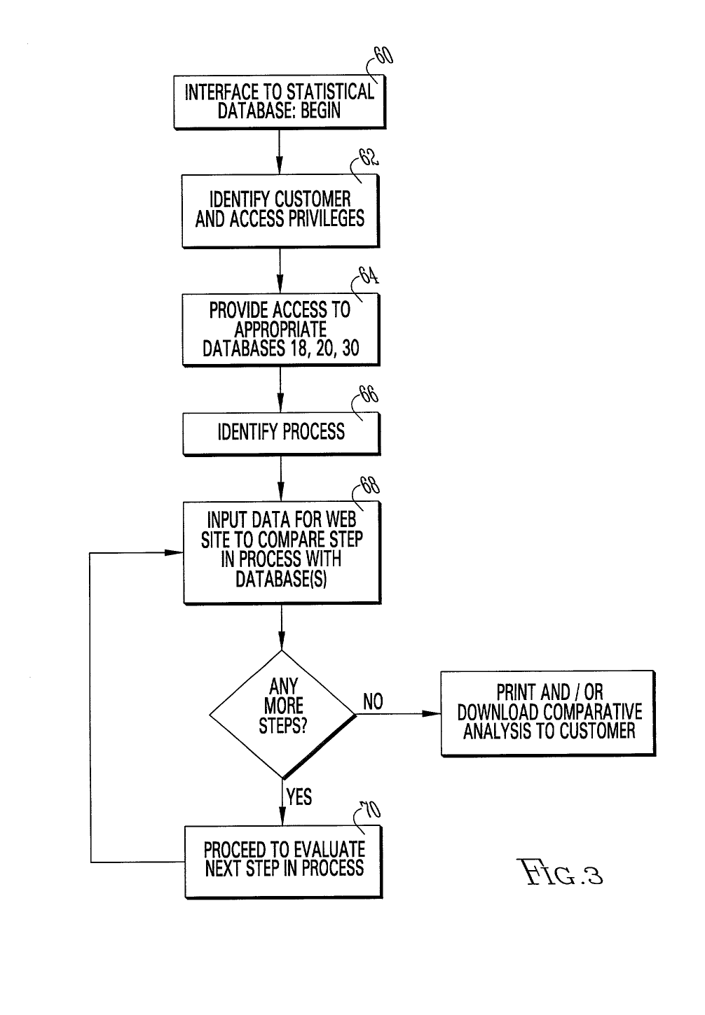

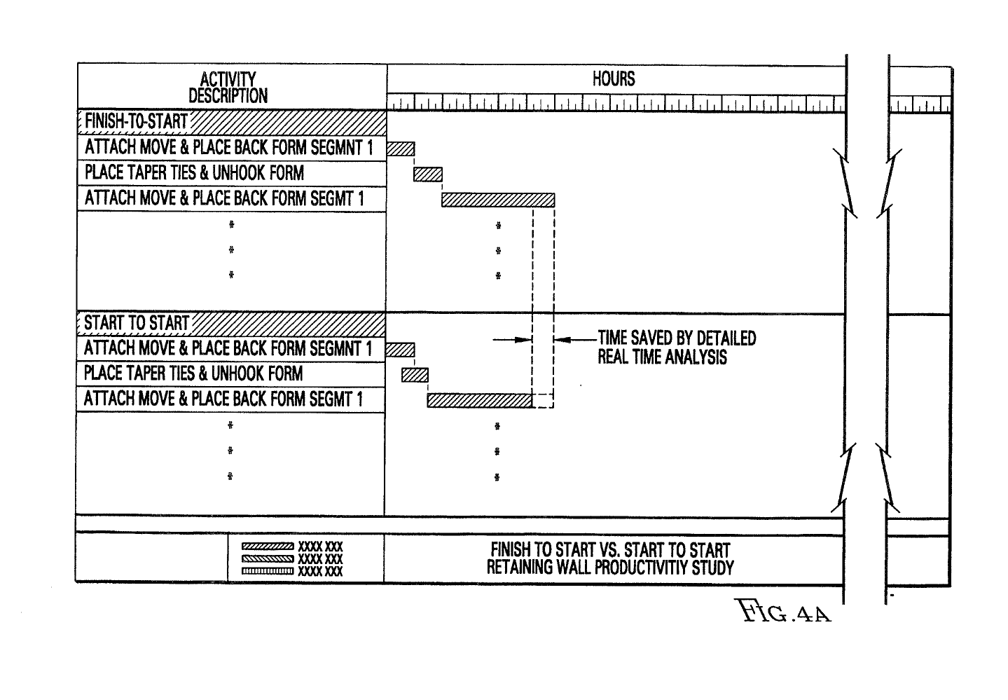

FIG. 2 shows flowchart methodology for interacting with the web site of FIG. 1 in accord with one embodiment of the invention;

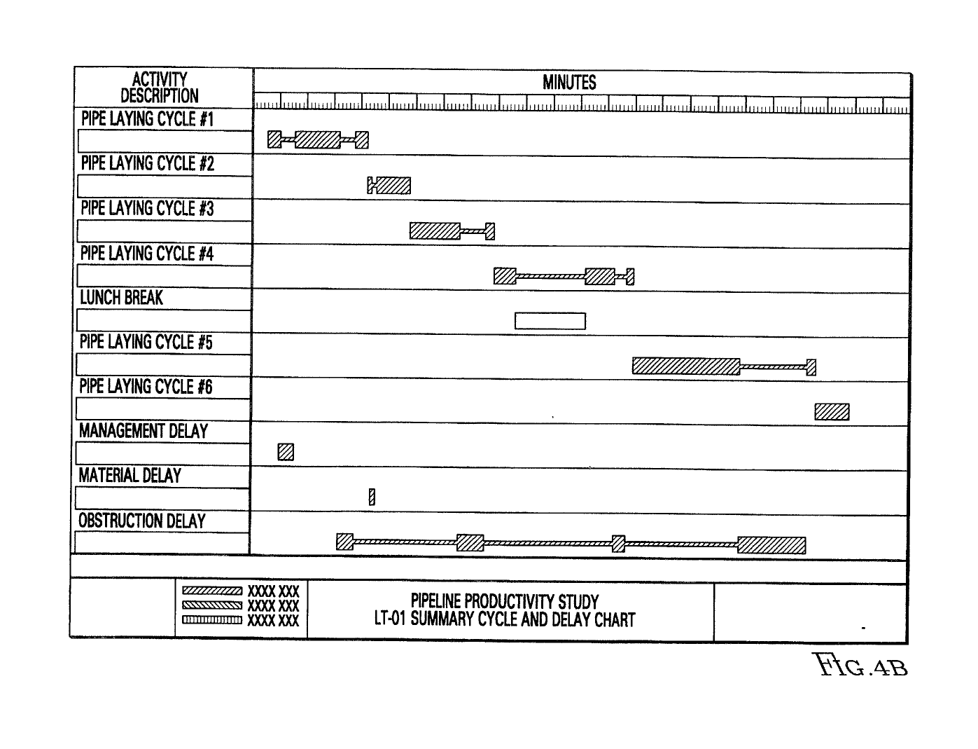

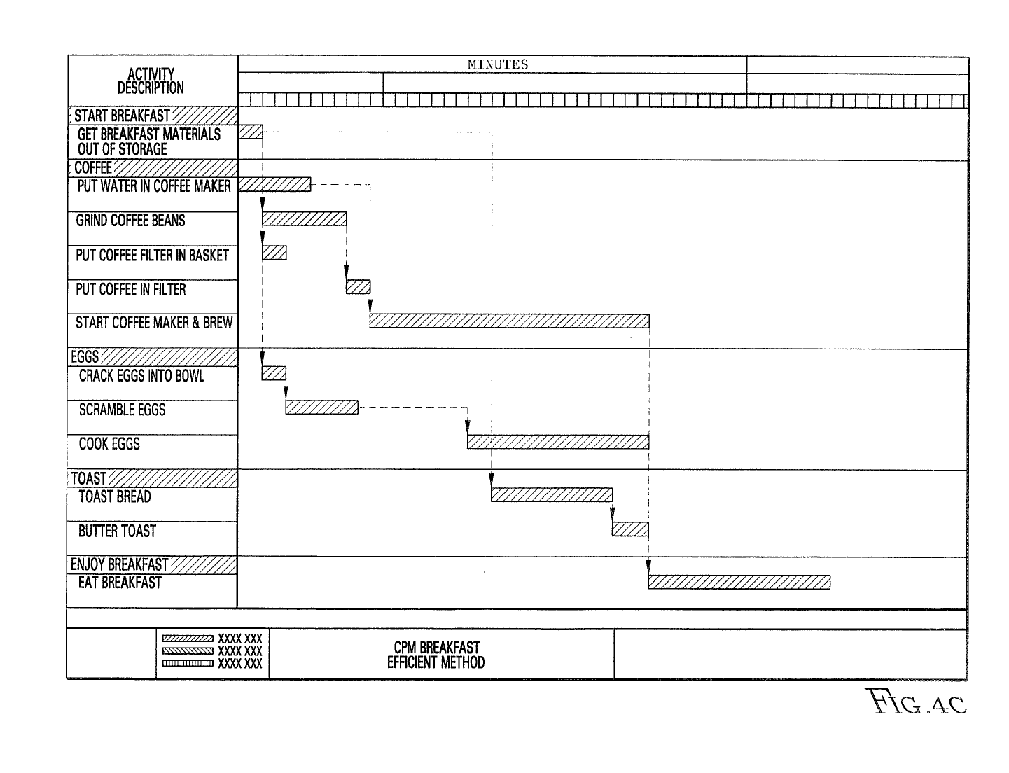

FIG. 3 illustrates flow chart methodology for augmenting statistical information in the web site of FIG. 1; and

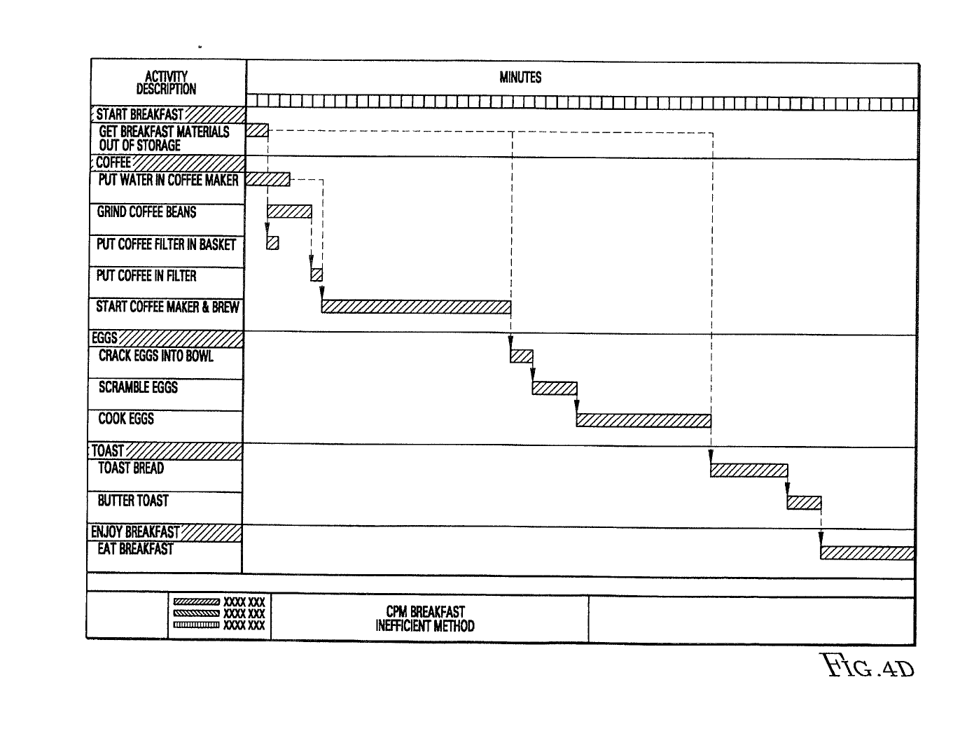

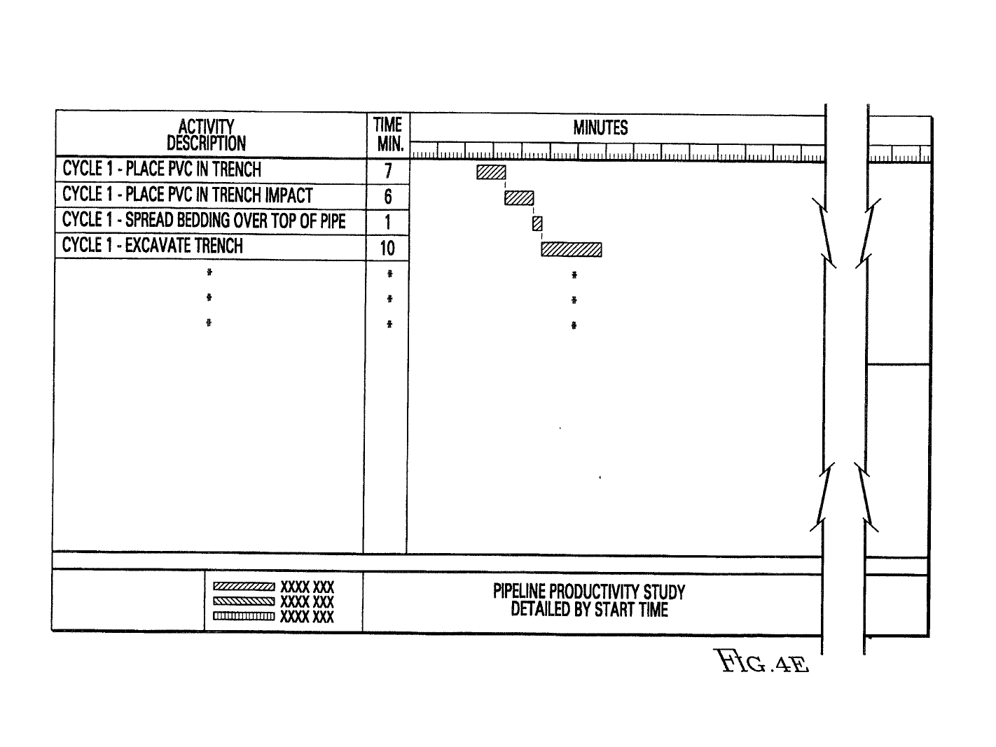

FIG. 4a-4e show representative statistical charts published by the web site of FIG. 1, the charts being modifiable according to preferred aspects to incorporate learning by construction sites.

### DETAILED DESCRIPTION OF THE INVENTION

FIG. 1 shows a system 8 constructed according to the invention. System 8 includes a web site 14 (e.g., in the form of a workstation) connected to the Internet 18. An array of construction sites 10₁₋ₙ are connected to web site 14 via Internet 18 by personal computers 12. Users at computers 12 can interact with web site 14 according to the methods herein.

The invention provides construction sites with real time training to assist with on-site construction jobs. Users of the invention can also predict productivity cycles associated with the job to predict man-hours and efficiencies. Users can augment their productivity predictions with real data to provide better and better prediction and efficiencies, through personalized databases at site 14 or through a master database available to all users.

By way of example, suppose construction site 10a involved constructing a retaining wall; and the construction crew realizes it needs assistance. A facilitator (e.g., a foreman) at site 10a accesses web site 14 via computer 12 through Internet 18 (those skilled in the art should appreciate that other communication mediums can be used as an alternative to Internet 18, or as a supplement thereto, including WANs, wireless networks, cable and fiber optics) to acquire the necessary just in time training. Specifically, web site 14 contains an array of training footage data 16a . . . 16m that may be downloaded or viewed by the facilitator at site 10a. By way of example, footage 16b can be training associated with constructing a retaining wall; and the facilitator at computer 12, site 10a, requests footage 16b for this purpose. By interacting with site 14, such as shown in FIG. 2, footage 16b is provided to computer 12 at site 10a. Footage 16b is preferably in the form of video and voice data that clearly instructs the facilitator (and/or workers at site 10a) how to construct the retaining wall.

Data at site 14 is therefore parsed into footage data 16a . . . 16m. Each footage data 16 typically represents less than ½ hour of video and voice data, and preferably less than about 10 minutes of video and voice data. Users at sites 10a . . . 10n can access footage 16a . . . 16m as needed during construction activities. Each construction site 10a . . . 10n can access site 14 as needed to acquire construction training footage.

Those skilled in the art should appreciate that footage data 16a . . . 16m, customer databases 18a . . . 18b, and master database 20 (databases 18 and 20 are described below) are shown illustratively with site 14; and that data storage can be virtual with links to other storage locations. For example, all data deriving from site 14 can in fact be housed at a different physical location that is essentially transparent to users of site 14. Supplemental databases 30 represent such external links to provide footage and/or other databases used by site 14, as needed, through an Internet link or WAN (or other communication link) 18′.

Sites 10a . . . 10m (or construction crews at some location connected to the Internet) can also acquire statistical guidelines for construction jobs prior to starting any given job. This is particularly useful to estimate manpower and duration issues for planning purposes. Specifically, each site 10 can access site 14 to, for example, estimate how long and how many men are required for a particular job. In the first instance, this information is obtained by master database 20. After the job, this same site 10 can augment its own statistics through its personalized customer database 18 for future use and planning, as shown in FIG. 3. Customer databases 18 are thus personalizable databases, one for a particular site 10, as desired or needed. Master database 20 can also be accessed by users of site 14 for general information, including general statistics for particular jobs for planning purposes.

Sites 10 do not require a personalized database 18 corresponding to each site 10; and that is a decision instead for the construction firm associated with site 10.

FIG. 2 shows one typical flow chart interaction between a site 10 and web site. Each user of computer 12 preferably has an access code to access site 14. That access code is obtained by a general contract with site 14, e.g., for so many dollars per year the user can access site 14, or an access code is obtained in real time by an e-commerce transaction, e.g., the user pays for a footage 16 as needed. Users at a site 10 who also have a general contract can additionally obtain a personal database 18 that they alone can access, perhaps for additional cost. A personal database permits a company to maintain and track statistics associated with certain of their jobs, and to augment those statistics for better and better predictions of job length, manpower needs, and cost. All users, including users with a personal database 18, can access master database 20 to obtain generalized statistics for planning purposes. It is preferred that all users also augment master database 20 too in accord with the process of FIG. 3 so that predictions are enhanced for all users; however that is not necessary. Master database 20 is mostly available for first time users and for pay-as you-go users. Thereafter, contract users can have the data ported to their personal database 18, as desired, to track and maintain their own statistics, such as through the process of FIG. 3.

Obtaining statistics for a particular job can take the form of FIGS. 4a-4e. Sites 10 can obtain such charts prior to a particular job, to assist in predicting timing and manpower needs (and costs); and sites 10 can thereafter fine-tune the charts to add information that they learn during a job, to provide even better statistics for future jobs. For example, FIG. 4a discloses the amount of time saving available for a start-to-start process versus a finish-to-start process. FIG. 4b discloses the delays per category that may be analyzed.

The invention also provides for other advantages. In one embodiment, the database has user-selected fields that allow one to shrink the amount of data being searched. For example, a user of the database may want to compare one company to another; but the user does not care about how it is done in Louisiana but only about how it is done in Colorado. Other important field separators are climatic and geographical conditions not necessarily the state in which the work is done.

The just-in-time construction training of another embodiment projects data to a wireless device like a cellular phone screen or a palm pilot-type device. Alternatively, certain digital pagers now have screens that are conceivably large enough to show the data. Wearable computers may be used. More particularly, the computer 12 of FIG. 1 can be replaced with such devices to eliminate the need for a direct connection to the Internet 18.

In still another aspect, training pictures and other data is compressed by animating the pictures and video processes, particularly for use with wireless applications.

Preferably, an additional element addressing cross-cultural issues will be included in the web site 14. These issues are work-related to the construction site and have to do with the work ethic and values of non-native United States Citizens. This portion of the web site 14 will seek to provide additional information on how cultural values affect the work product.

In another aspect, a statistical database 18 and/or 30 is used to separate the true random variation in a process from a real variation and to assist in focusing on the improvement of that non-random variation. Portions of the statistical analysis and the production charts will make use of certain specific existing pieces of software.

Data from system 8 will import into other software to produce the charts and graphs that will assist in the clarification of the real time productivity analysis.

Portions of the just-in-time training of the invention can also be applied to the administrative functions of the construction firm's home office. This would include the use of estimating, and scheduling software as well as certain administrative functions such as time card preparation, force account and extra work preparation, change order preparation and other administrative functions of the home office of the contractor.

The invention thus attains the objects set forth above, among those apparent from preceding description. Since certain changes may be made in the above systems and methods without departing from the scope of the invention, it is intended that all matter contained in the above description or shown in the accompanying drawing be interpreted as illustrative and not in a limiting sense.

What is claimed is:

1. A system for providing select construction training information, comprising:
a web site having one or more training footage data corresponding to the select construction training information, the web site having connection to a communication link that facilitates communication to one or more construction sites in need of the select construction training information, the web site responding to computerized requests from the sites to provide the training footage data to appropriate construction sites.

2. A system of claim 1, wherein the web site comprises one or more databases, or links to databases, for storing statistical information regarding the select construction training information, the statistical information providing guidance to one or more construction sites as to manpower, duration and/or cost of the select construction training information.

3. A system of claim 2, further comprising software for facilitating modifications to the statistical information based upon actual construction data from one or more construction sites.

4. A system of claim 2, the web site having one or more customer databases for storing personalized statistical information for a particular construction firm.

5. A system of claim 2, the web site having a master database for generalized statistical information for any construction firm that pays for access to the web site.

6. A system of claim 2, the web site further comprising a customer code for access to the master database and customer database and to manipulate personalized statistical information.

7. A system of claim 6, the customer code being obtained in real time by an e-commerce transaction.

8. A method of acquiring constructing training data in near real time, comprising the steps of: accessing, through payment, one or more training footage data representing at least one of video and voice data less than about ½ hour; selecting the footage data; and downloading the selected footage data to a construction site for training construction workers at the site.

9. A method of claim 8, wherein the step of accessing, through payment, one or more training footage data comprises the step of accessing, through payment, a web page having one or more training footage data representing at least one of video and voice data less than about ½ hour; selecting the footage data; and downloading the selected footage data to a construction site for training construction workers at the site.

10. A method of claim 8, wherein the step of accessing, through payment, one or more training footage data comprises the step of accessing, through payment, a wide area network having one or more training footage data representing at least one of video and voice data less than about ½ hour; selecting the footage data; and downloading the selected footage data to a construction site for training construction workers at the site.

11. A method of claim 8, wherein the step of accessing, through payment, one or more training footage data comprises the step of accessing, through payment, a wireless network having one or more training footage data representing at least one of video and voice data less than about ½ hour; selecting the footage data; and downloading the selected footage data to a construction site for training construction workers at the site.

12. A method of claim 8, wherein the step of accessing, through payment, one or more training footage data comprises the step of accessing, through payment, a fiber optic network having one or more training footage data representing at least one of video and voice data less than about ½ hour; selecting the footage data; and downloading the selected footage data to a construction site for training construction workers at the site.

13. A method of claim 8, wherein the step of accessing, through payment, one or more training footage data comprises the step of accessing, through payment, a cable network having one or more training footage data representing at least one of video and voice data less than about ½ hour; selecting the footage data; and downloading the selected footage data to a construction site for training construction workers at the site.

14. A method of claim 6, further comprising compressing the footage data into animation.

15. A method of claim 6, further comprising downloading the selected, footage data to the construction site via the Internet.

16. A method of claim 6, further comprising downloading the selected footage data to the construction site via wireless communication.
